(19) United States
(12) Patent Application Publication
(10) Pub. No.: US 2016/0311354 A1
(43) Pub. Date: Oct. 27, 2016

(54) BACK SUPPORT DEVICE AND SYSTEM

(71) Applicant: Craig Allen Stamm, Evansville, WI (US)

(72) Inventor: Craig Allen Stamm, Evansville, WI (US)

(21) Appl. No.: 15/138,204

(22) Filed: Apr. 25, 2016

Related U.S. Application Data
(60) Provisional application No. 62/151,712, filed on Apr. 23, 2015.

(51) Int. Cl. B60N 2/66; A47C 7/46; A47C 7/40; A47C 7/42; B60N 2/64

(52) U.S. Cl. CPC B60N 2/663; A47C 7/425; B60N 2/643; B60N 2/666; A47C 7/402; A47C 7/46

(57) ABSTRACT

A back support system includes a rigid frame being secured to the backrest of a chair, and a back brace wearable by the user, wherein the back brace is attachable to the frame, such that when the user leans into the backrest, the back brace attaches to the frame, and when the user sinks into the seat of the chair, the vertebrae in the user's lumbar region may be separated and pressure therebetween may be relieved. The frame includes a vertical securing member to prevent the frame from being displaced downward toward the seat of the chair. The frame and back brace each includes an attachment member to engage each other when the user wearing the back brace leans into the frame.

### CROSS REFERENCE TO RELATED APPLICATIONS

The application claims the benefit of U.S. Provisional Application No. 62/151,712, filed on Apr. 23, 2015, which is incorporated by reference herein in its entirety.

### FIELD OF INVENTION

The invention is related to a back support device and system for reducing back pain, more particularly a device and system that may be used with a chair, such as a car seat. The invention is directed generally to reduce pain experienced by the user in the lumbar region of the back while driving or sitting.

### BACKGROUND OF THE INVENTION

The invention relates generally to a back support device and system, more particularly for reducing back pain in the lumbar region while sitting, such as in a car. For example, the invention may be used by a person sitting in a car, such as the driver of the car.

Back pain is a common ailment, suffered by approximately 80 percent of the American population. Whereas there are many sources of back pain, some common causes of back pain, particularly in the lumbar region, is the compression of nerves due to herniated or ruptured discs, and a degenerative disc disease.

There are several known methods for treating these types of back pain, such as medicine, hot/cold packs, injections, exercise and various treatments. When the back pain is chronic, some people opt for treatments such as spinal adjustment, massage, transcutaneous electrical nerve stimulation wherein mild electrical pulses are sent to the nerves, acupuncture and acupressure.

One common method of treatment includes easing the pressure applied by the upper portion of the body onto the lumbar region. Inversion tables and stretchers are examples of devices available. Inversion tables generally require the user to strap in and secure their feet and/or ankle, lie down on the table and invert it, so that the feet are above the head, thus using the body weight to separate the vertebrae and relieve the pressure therebetween. Stretchers commonly require the user to place the stretcher on the ground and lie on top of it to stretch the vertebrae. Both of these devices generally require the user to be lying down. Generally, they cannot be used while sitting, especially while driving.

Whereas there are back cushions that users may use while sitting, such cushions may also have several drawbacks. For example, the cushion may become heated and uncomfortable for the user, especially on a hot day. The shape of the cushion may not fit the user well because of the user's height, size, etc. The forced arch of the back created by the cushion may be uncomfortable for some users.

Accordingly, it is desirable to provide an improved system and device for reducing back pain while sitting, which overcome drawbacks and inadequacies of known devices and systems.

### SUMMARY OF THE INVENTIONS

Generally speaking, in accordance with an embodiment of the invention, a back pain relief system includes a frame that is secured onto the front of a backrest of a chair, a back brace that a user wraps around the user's body, for example the lumbar region of the spine, and a securing mechanism that secures the back brace onto the frame to prevent the back brace from being inadvertently displaced from the frame. The securing mechanism preferably attaches the back brace onto the frame when the user wearing the back brace leans into the frame.

An embodiment of the invention provides a frame having one or more hooks extending from the top of the frame, the hooks being designed to engage the top of the backrest to prevent the frame from being displaced downward. Thus, when the user leans into the backrest, thus engaging the securing mechanism of the back brace and the frame and therefore attaching the back brace to the frame, and settles into the seat, the frame does not shift toward the seat, and the vertebrae in the lumbar region are preferably separated. Such an arrangement may further prevent the user from slouching.

Another embodiment of the invention is directed to a frame having one or more straps which wrap around the backrest to secure the frame onto the backseat and preferably prevent the frame from being displaced from the backrest.

Still other objects and advantages of the invention will in part be obvious and will in part be apparent from the specification. Other features and advantages of this invention will become apparent in the following detailed description of exemplary embodiments of this invention with reference to the accompanying drawings.

### BRIEF DESCRIPTION OF THE DRAWINGS

For a fuller understanding of the invention, reference is made to the following description taken in connection with the accompanying drawing, in which:

FIG. 1 is a perspective view of a device in accordance with an embodiment of the invention;

FIG. 2 is a perspective view of a system in accordance with an embodiment of the invention;

FIG. 3 is a perspective view of a seat having the device of FIG. 1 positioned thereon;

FIG. 4 is a perspective view of a seat having the system of FIG. 2 positioned thereon;

FIG. 5 is a rear perspective view of the seat of FIG. 3;

FIG. 6 is a perspective view of the device of FIG. 1 without the strap;

FIG. 7 is a perspective view of a back brace in accordance with an embodiment of the invention;

FIG. 8 is a rear perspective of a back brace in accordance with an embodiment of the invention;

FIG. 9 is a perspective view of a device in accordance with an embodiment of the invention; and

FIG. 10 is a diagram of a user sitting in a seat while utilizing the system of FIG. 2.

### DETAILED DESCRIPTION OF THE PREFERRED EMBODIMENTS

The invention generally is directed to a system and device for placement on the backrest of a seat such as a chair or car seat, more specifically a device that may be secured onto the backrest of a seat and a back brace that attaches to the device. The system may prevent or limit the movement of the user's upper body to prevent or reduce pressure applied on the user's lumbar region while the user remains seated in the seat. By securing the device to a backrest of the seat and attaching a back brace which wraps around the user's torso to the device, the pressure applied on the user's lumbar region may be reduced. Certain embodiments of the invention are described herebelow.

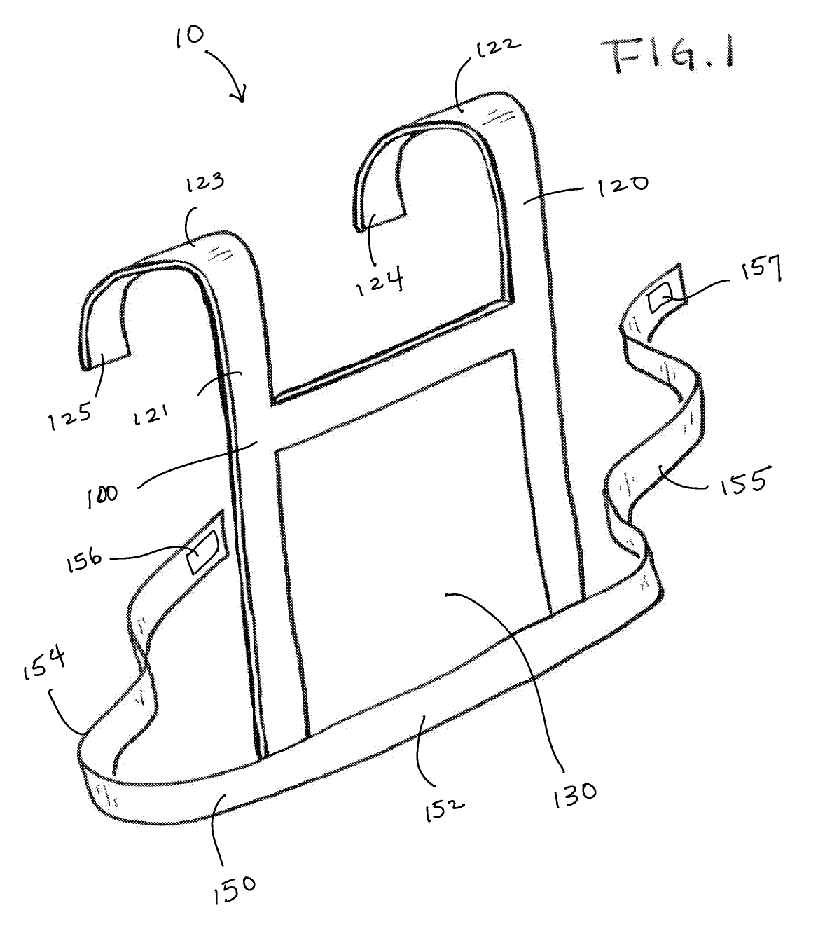

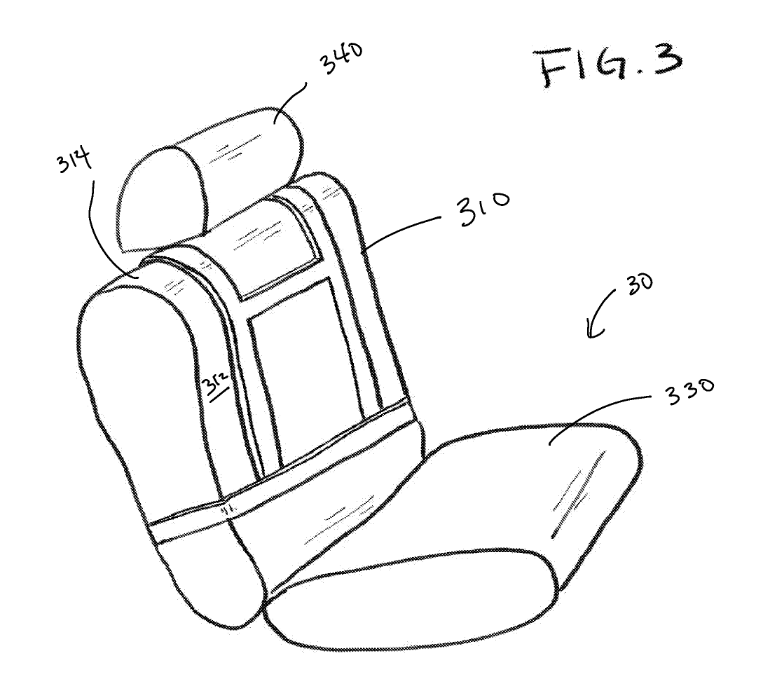

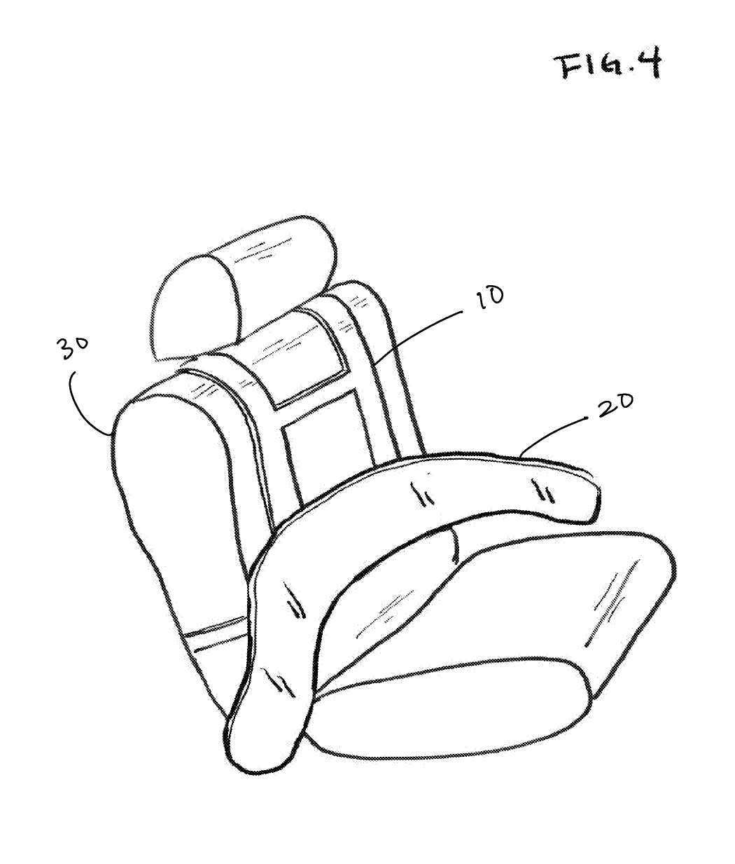

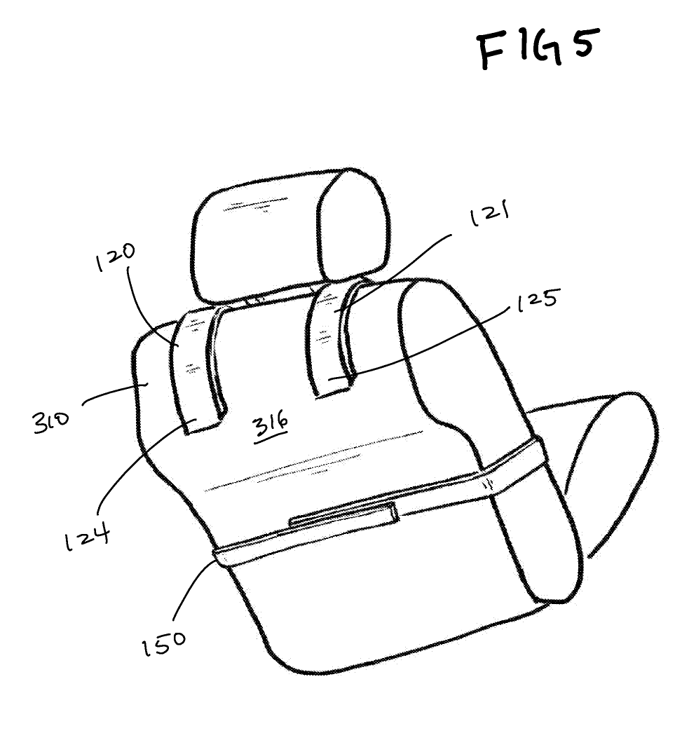

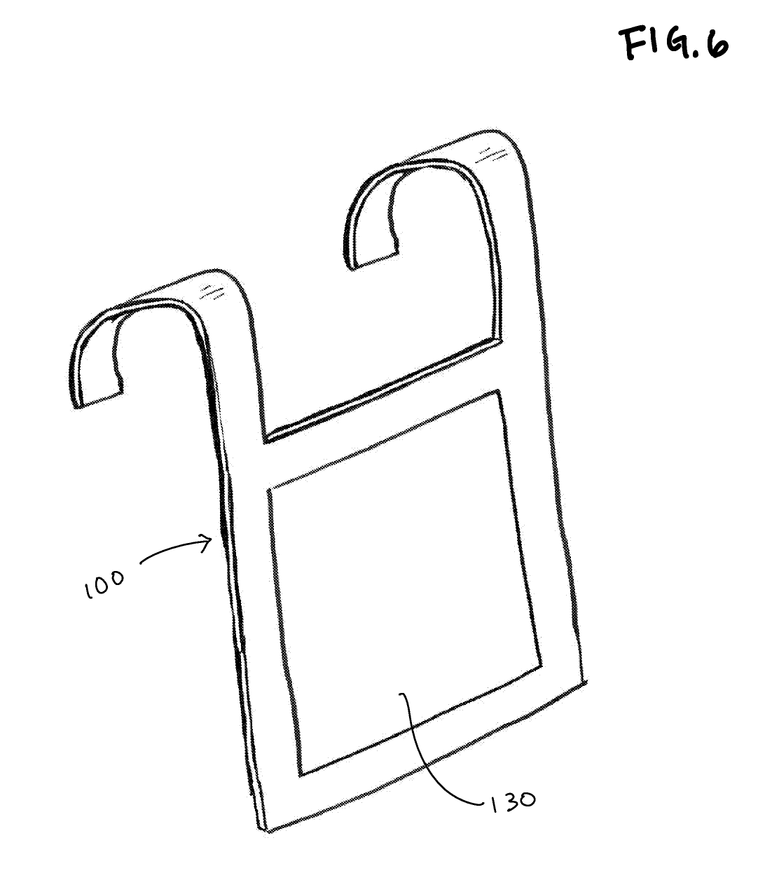

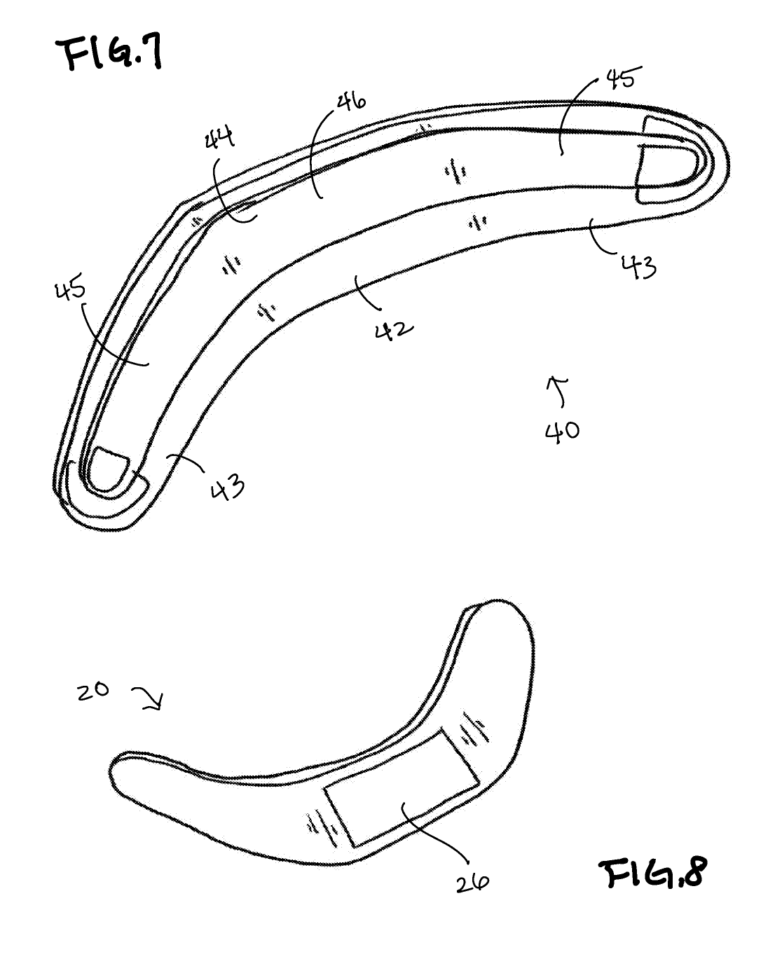

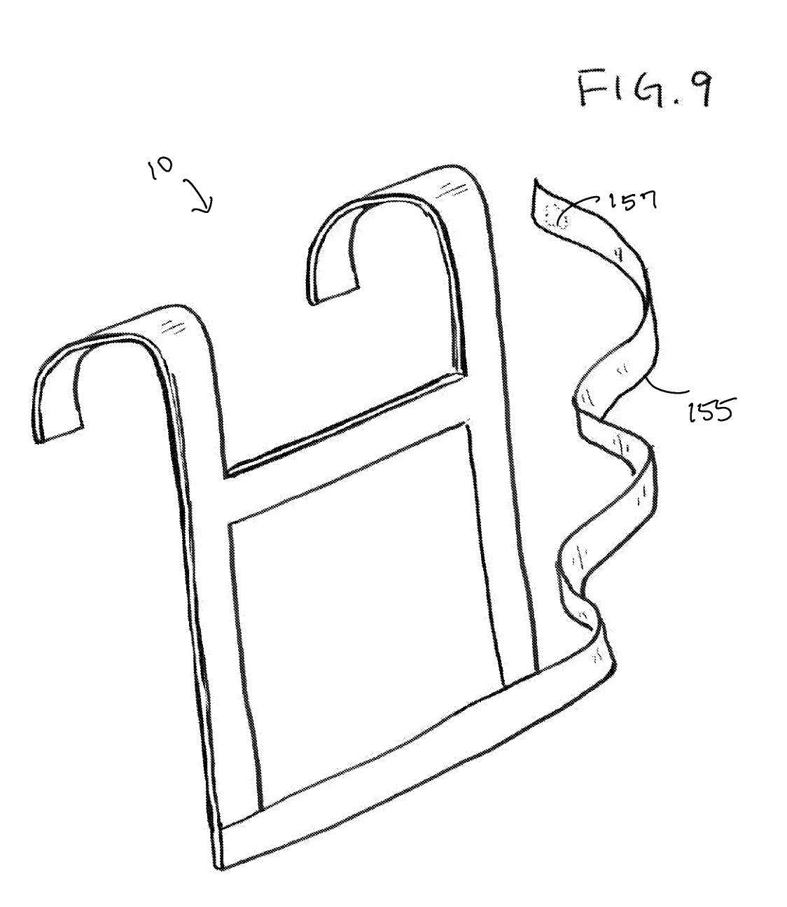

Reference is made to FIGS. 1-10, wherein a system 1 is illustrated having a device 10 and a back brace 20. In the embodiment shown, device 10 is a structure to which a back brace 20 may be attached. Device 10 as shown includes a panel 100, two arms 120, 121 extending from panel 100 and a strap 150. Arms 120, 121 extend vertically away from panel 100 and include curved portions 122, 123 and distal ends 124, 125 at the distal end away from panel 100. Curved portions 122, 123 are preferably designed to hook onto the top part of the backrest 310 of seat 30, such that when panel 100 is placed on the front side 312 of backrest 310, curved portions 122, 123 contact the top portion 314 of backrest, as shown in FIG. 3 and distal ends 124, 125 are located on the opposite side of backrest 310 as shown in FIG. 5.

Panel 100 is preferably relatively flat and lays parallel to the front side 312 of backrest 310. In accordance with a preferred embodiment of the invention, panel 100 is relatively rigid and maintains its shape under moderate force. More specifically, device 10 overall is rigid enough to maintain its shape, more preferably vertically, so that when back brace 20 is attached thereto, back brace 20 will not be inadvertently displaced vertically. For example, if the user slouches, system 1 will maintain the user's torso in place with respect to backrest 310 and will not move with the user's movement. In accordance with a preferred embodiment, panel 100 and arms 120, 121 are formed of a rigid material such as a rigid polymer.

The user may attach back brace 20 onto device 10 prior to sitting or while getting into seat 30. Preferably, back brace 20 is positioned on device 10 to stretch the lumbar portion of the user's spine, separating the vertebrae by maintaining the portion of the spine within back brace 20 in place while the lower body settles into the seat. Furthermore, by maintaining the portion of the user's spine within back brace 20 in place, system 1 preferably significantly maintains the vertebrae separated. Additionally, system 1 preferably eliminates or reduces the pressure applied by the user's upper body onto the lumbar region by preventing or reducing the movement of the user's upper body.

An alternative embodiment of the panel may be adjustable vertically, for example, by including a telescoping mechanism. Therefore, depending on the height of the user, the length of panel 100 may be adjusted. An adjustable panel may be preferred for use in a car, home, office, etc. that is shared among users of varying heights, such as family members, friends, etc. Once the length of the panel is adjusted, the panel preferably locks in position, so that the panel remains at the selected height until readjusted.

Whereas panel 100 and device 10 have been described as having a rigid structure, panel 100 and/or arms may alternatively be made of a flexible structure that may bend according to the shape of the backrest 310 without deviating from the scope of the invention. However, panel 100 preferably does not stretch, so that the position of back brace 20 may be maintained.

In the embodiment illustrated, panel 100 includes a frame 110 and an attachment surface 130 on the front side of frame 110, such that when device 10 is positioned on backrest 310, attachment surface 130 is positioned to attach to back brace 20. Preferably, attachment surface 130 is permanently attached onto panel 100 and is not removable, and is secure enough to stay attached when back brace 20 is being removed from device 10. More particularly, in the embodiment shown, attachment surface 130 faces the user's back to attach to the rear of back brace 20. Preferably, back brace 20 is removably attachable to device 10 via a brace attachment portion 26 as illustrated in FIG. 8, so that the user may either place back brace 20 on prior to or after attaching back brace 20 onto panel 100. Also, the user may adjust the position of back brace 20 on panel 100 until the user obtains the desired pressure on the lumbar region and position of back brace 20. Attachment surface 130 may include hooks or loops to attach to corresponding loops or hooks on the rear side of back brace 20. Other attachments mechanisms may be used without deviating from the scope of the invention. By way of non-limiting example, the attachment mechanism may include a magnet, adhesive or other means of attaching back brace 20 to device 10.

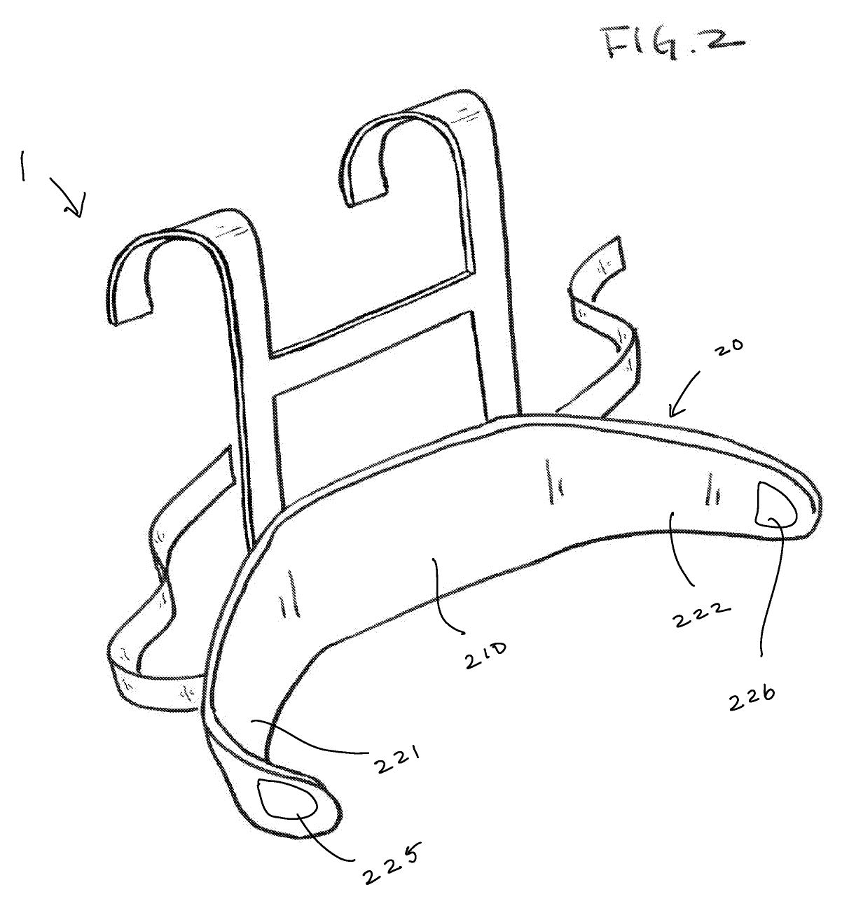

As shown in FIG. 2, attachment surface 130 preferably has a greater vertical length than back brace 20, thus permitting various positions vertically of back brace 20 on attachment surface 130. Therefore, the user may vary the amount of stretching provided on the lumbar region every time the user attaches back brace 20 onto device 10. Additionally, such an arrangement may facilitate the user utilizing system 1 by permitting the user to simply lean back into the seat to attach back brace 20 onto attachment surface 130 without requiring precise positioning. Furthermore, users of varying heights, needs, etc. may use the same system 1. An exemplary length of attachment surface 130 is between 6 and 15 inches, more preferably around 10 inches. Attachment surface 130 preferably has a width between 3 and 8 inches, more preferably around 5 inches. Attachment surface 130 is preferably wide enough so that the user may sit in seat 30 and lean into backrest 310 to attach back brace 20 to device 10 without requiring precise positioning thereof. Brace attachment portion 26 preferably has a length of 3 and 7 inches, preferably around 5 inches, and a width of 3 and 7 inches, preferably around 5 inches.

The illustrated embodiment of the system provides a removably attachable back brace 20. However, it is to be understood that back brace 20 may be permanently attached to panel 100 without deviating from the scope of the invention.

Additionally, whereas frame 110 is illustrated as being a unitary piece having attachment surface 130 proximate its center, it is to be understood that the position of attachment surface 130 may be varied without deviating from the scope of the invention. Furthermore, frame 110 may comprises a plurality of pieces, rather than a unitary piece. Also, whereas in the embodiment illustrated, attachment surface 130 does not extend to the outer edges of panel 100, it is to be understood that attachment surface 130 may extend to either side and/or upward up to arms 120, 121.

Panel 100 is preferably secured in place on backrest 310 by arms 120, 121 and strap 150 which, as illustrated in FIGS. 3 and 5, wraps around the sides of backrest 310. Strap 150 preferably includes one or more extensions 154, 155 which may meet on the rear side 316 of backrest 310 and attach to each other as shown in FIG. 5. Extensions 154, 155 preferably include one or more attaching members 156, 157 to attach to each other, such as Velcro, a hook-and-eye mechanism, button, magnet, clasp, or buckle, by way of non-limiting example. Whereas attaching members 156, 157 are illustrated as being located proximate the distal ends of extensions 154, 155, it is to be understood that the attaching members may be located anywhere along the length of extensions 154, 155, on either surface, as a matter of application-specific design choice.

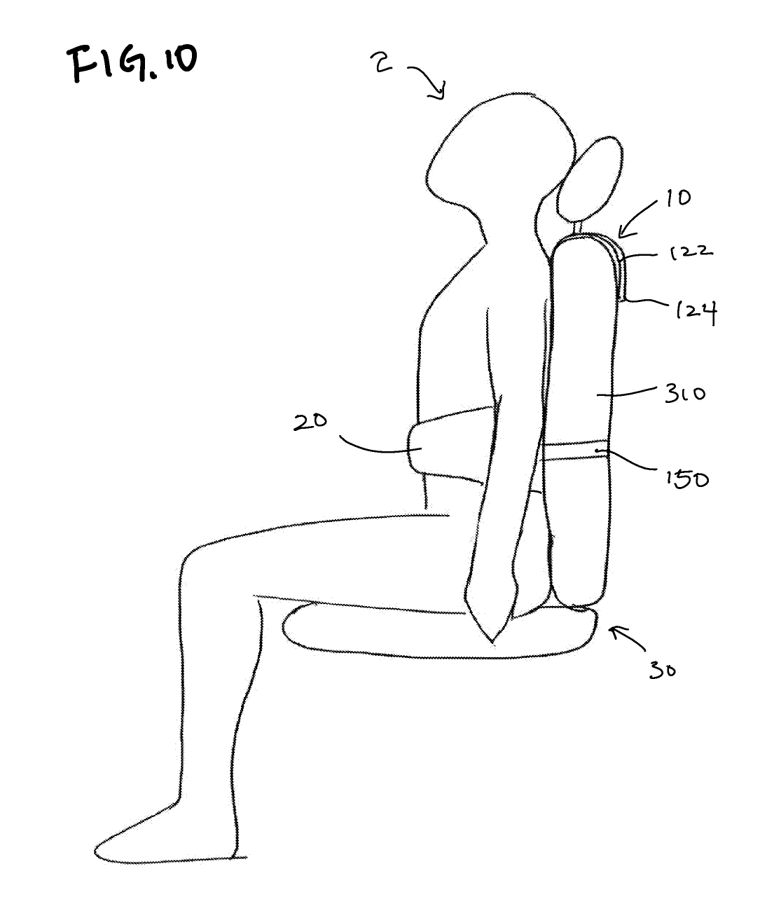

Alternatively, an embodiment of device 10 may include a single extension 154 as shown in FIG. 9. Extension 154 may wrap around backrest 310, extends past the backside 316 and attach to strap 150 on front side 312 or the back side of backrest 310. Extension 154 may additionally or alternatively attach to panel 100 and/or one or more arms 120, 121. Strap 150 may further include two or more extensions which extend past rear side 316 to front side 312 of backrest 310, or a combination of extensions of varying lengths as a matter of application-specific design choice.

Extensions 154, 155 of strap 150 are preferably constructed of a flexible material, such as, by non-limiting example, nylon, polyester or cotton, so that they may wrap around backrest 310 and fit the contours thereof. The middle portion 152 of strap 150 is preferably attached to panel 100, either removably or permanently. Middle portion 152 may be of similar rigidity as panel 100 or of similar flexibility as extensions 154, 155. More preferably, middle portion 152 is permanently attached to panel 100 and has a similar flexibility as extensions 154, 155. Whereas in the embodiments shown, strap 150 is shown proximate the bottom of panel 100, but it may be higher up along panel 100 without deviating from the scope of the invention.

Back brace 20 preferably includes back portion 210 and two side portions 221a, 222 having a securing mechanism 225, 226. A user preferably secures back brace 20 around his waist by placing back portion 210 along his spine at the desired position, wrapping side portions 221, 222 around his torso forward toward his stomach, and securing side portions 221, 222 to each other. Side portions 221, 222 preferably form a tubular form when attached to each other. For example, side portions 221, 222 be secured and tightened by overlapping the ends to adjust to the wearer's torso size.

Alternatively, one or more side portions 221, 222 may extend all the way around the user's abdomen and attach to back portion 210, or wrap around completely and attach to itself, or to other parts of back brace 20. Back brace 20 is preferably made from a non-rigid material to adjust according to the user's torso, and preferably conform thereto. Back brace may be secured onto the user's torso via a hooks-and-loops system, magnets, zippers and buttons, by way of non-limiting example, more preferably via a hooks-and-loops system.

As discussed above, back brace 20 is preferably removably attached to device 10. Preferably, the rear side of back portion 210 includes hooks and attachment surface 130 comprises loops to provide the removable attachment between back brace 20 and device 10.

FIG. 7 illustrates an embodiment of back brace 40 which includes an outer brace 42 and an inner brace 44, each having sides that wrap around the user's torso and attach to each other. Preferably, outer brace 42 and inner brace 44 are attached to each other proximate back portion 46, whereas the sides are separated. Therefore, the user may wrap the inner arms 43 around his torso and secure them in place, then wrap the outer arms 45 around his torso and secure them in place.

An illustration of an exemplary use of system 1 is provided in FIG. 10, which shows a user 2 sitting in seat 30 and leaning into backrest 310. Back brace 20 is wrapped around his torso and is attached to device 10. As shown, distal end 124 of arm 120 is positioned on the back side of backrest 310, and top portion 122 is positioned proximate the top of backrest 310. Strap 150 extends around backrest 310 from the front of backrest 310 to the back to secure device 10 in place.

An embodiment of how system 1 is utilized by a user will be described herein. The user may place back brace 20 around the user's waist, preferably slightly above the waist, wrapping it around and securing it around the waist at the desired position. The user may lower his body into seat 30, and raise his body slightly when reclining into seat 30, then lean into panel 100 of device 10. The rear of back brace 30 thus contacts attachment surface 130 of device 10, forming a secure bond therewith. As mentioned above, back brace 30 may attach to attachment surface 130 via loops and hooks such as Velcro®. This bond preferably allows the user to sink into seat 30 without breaking the bond while back brace 20 holds up the upper portion of the user's body. This preferably results in relieving the pressure on the lumbar region of the back and reducing the pain.

One of the potential benefits of using a loop and hook securing mechanism is that a loop patch attached to a hook patch typically forms a nearly unbreakable bond when pulled in a motion generally parallel to the plane of the patches (in this case the user lowering their body). Conversely the patches may be pulled apart relatively easily, releasing back brace 20 from device 10 when the user pulls forward, which pulls the patches apart in a motion generally perpendicular to the plane of the patches, allowing the user to remove himself from or readjust himself to device 10. However, the user typically must pull forward with sufficient force or to a sufficient distance for back brace 20 to separate from device 10. Thus, back brace 20 preferably does not separate from device 10 just by the user leaning slightly forward, for example, while driving.

Even with back cushions, back braces, and other portable items that may be used in a car, office, etc., none of them limits the user's movement with respect to the backrest and prevents the user from slouching. Slouching may increase the pressure the user's upper body places on the lumbar region. The system 1 in contrast secures the user's torso in place with respect to the backrest 310 of seat 30, thus making it significantly more unlikely that the user will slouch.

Whereas the terms “vertical,” “higher,” “bottom,” etc. are used herein, it is to be understood that such terms are used for illustrative purposes only, and do not imply device 10 must be utilized in an upright position as illustrated. Rather, system 1 may be used at any angle, including vertical and horizontal arrangements. It may be used with arms 120, 121 extending upward away from seat bottom 330 or downward tow. Device may be used horizontally, so that the arms extend horizontally, rather than vertically.

Other alterations may be made without deviating from the scope of the invention. Accordingly, the system and method, the use, steps, order of steps, etc. may be varied as a matter of application specific design choice without deviating from the scope of the invention. For example, back brace 20 may be permanently attached to device 10. Additionally, whereas two arms 120, 121 are illustrated, the number of arms may be varied without deviating from the scope of the invention.

Another alternate embodiment of the device does not include a strap to wrap around the backrest. For example, the backrest may include a securing mechanism, such as one or more buttons, apertures, loops, slots, folds, hook-and-loop patches, magnets or pieces of metal, etc. and the device may include one or more corresponding hooks, loops, buttons, apertures, hook-and-loop patches, magnets or pieces of metal, etc. to secure the device onto the backrest. Alternatively, the backrest may include a sleeve or other item having such a securing mechanism to engage the device's securing mechanism. In accordance with another embodiment, the device may be secured to the bottom of the backrest or the seat.

It is the intention, therefore, to be limited only as indicated by the scope of the claims appended hereto. It is also to be understood that the following claims are intended to cover all of the generic and specific features of the invention herein described and all statements of the scope of the invention which, as a matter of language, might be said to fall there between.

We claim:

1. A back support system comprising
a support device having a frame, a panel and a securing member;
wherein
said frame comprises a hook to engage a top of a backrest of a chair and prevent said support device from sliding downward along said backrest;
said panel comprises a panel attachment member;
said securing member comprises a strap to wrap around said backrest and secure said support device onto said backrest; and
a back brace having a brace attachment member on an exterior surface;
wherein said panel attachment member and said brace attachment member engage to attach said back brace to said panel.

2. A back support system comprising
a support device having a securing mechanism for securing said support device to a backrest of a chair, said support device having a first attaching member; and
a back brace having a second attaching member for attaching said back brace to said support device.

3. The back support system of claim 2, wherein said securing mechanism includes a hook extending from a top of said securing mechanism.

4. The back support system of claim 2, wherein said securing mechanism includes a strap which wraps around said backrest and secures said support device onto said backrest.

5. The back support system of claim 4, wherein said strap extends from a side of said support device.

6. The back support system of claim 2, wherein said first attachment member and said second attachment member are hook-and-loop fasteners.

7. The back support system of claim 2, wherein said second attachment member is located on a rear exterior surface of said back brace.

8. The back support system of claim 2, wherein said first attachment member has a first surface and said second attachment member has a second surface area less than said first surface area.

9. The back support system of claim 2, wherein said first attachment member is located on a front surface of said support device.

10. The back support system of claim 2, wherein said support device further comprises a rigid frame.

11. The back support system of claim 2, wherein said back brace includes an inner belt and an outer belt, said inner belt being attached to an inner surface of said outer belt, wherein said outer belt has an exterior surface comprising said second attachment member.

12. The back support system of claim 2, wherein said support device has an adjustable frame to provide a plurality of lengths.

13. The back support system of claim 2, wherein said support device has a plurality of securing members to secure said support device onto said backrest.

14. The back support system of claim 2, wherein said first attachment member and said second attachment member attach to each other upon contact.

15. A device comprising:
a frame;
a vertical securing member;
a lateral securing member; and
a panel having an attachment member.

16. The device of claim 15, wherein said frame comprises a rigid material.

17. The device of claim 15, wherein said vertical securing member comprises a rigid hook extending vertically from a top of said frame, said rigid hook being shaped to engage a top of a chair, such that when said hook engages said top of said chair, said hook prevents said securing member from being displaced away from said top.

18. The device of claim 15, wherein said lateral securing member comprises a flexible strap extending from a side of said frame.

19. The device of claim 18, wherein said flexible strap extends from a first side of said frame and attaches to an opposite side of said frame.

20. The device of claim 18, wherein said attachment member comprises a hook-and-loop fastener.
